(19) United States
(12) Patent Application Publication
(10) Pub. No.: US 2022/0414609 A1
(43) Pub. Date: Dec. 29, 2022

(54) CREATING WORK ORDER PLANS AND STEPS BASED ON MAPPED FIELDS

(71) Applicant: salesforce.com, inc., San Francisco, CA (US)

(72) Inventors: Dai Duong Doan, Alameda, CA (US); Rupa Singh, Fremont, CA (US); Shanis Kurundrayil, Fremont, CA (US); Keye Liu, Hercules, CA (US)

(73) Assignee: salesforce.com, inc., San Francisco, CA (US)

(21) Appl. No.: 17/360,032

(22) Filed: Jun. 28, 2021

(51) Int. Cl. G06Q 10/00; G06Q 10/06; G06Q 30/00; G06F 16/245; G06F 16/248

(52) U.S. Cl. CPC G06Q 10/20; G06Q 10/067; G06Q 10/06315; G06Q 30/016; G06F 16/245; G06F 16/248

(57) ABSTRACT

Creating work order plans and steps based on mapped fields is described. A database system receives an input associated with a work order, and then identifies a work plan template object, a work plan instance object, a work step template object, and a work step instance object associated with the work order. The database system identifies work plan fields which are mapped from the work plan template object to the work plan instance object, and work step fields which are mapped from the work step template object to the work step instance object. The database system creates at least one work plan which includes the mapped work plan fields in the work plan instance object and work steps which include the mapped work step fields in the work step instance object. The database system outputs the work order which includes the at least one work plan.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

A work order can be a physical or electronic document that specifies what activity is to be completed to accomplish a goal. A work order can provide additional details, such as materials used to accomplish the goal and the materials' prices. Sometimes referred to as a service ticket, job order, or work ticket, a work order may be sent from an outside customer to an organization or used internally by an organization to request work from a specific department.

A user such as a customer service representative can enter work order information into a computer that displays various work order templates to generate specific types of work orders. For example, maintenance work order templates can include sections for a user to enter work details, labor and material costs, location, and a start date. A service work order template enables a user to input the service provided, any parts required, any additional charges, and the service date.

In a template for repairs to a building, a user can describe the repairs needed, assign due dates for completing the repairs, and document any expenses. A user can fill out information about a car at the top of an automotive work order template for maintenance or repair work, and then add details about labor and parts in the spaces below. A user can record a requested Information Technology (IT) action, the date of the request, and details about the work in an IT services work order. Additionally, a user can keep track of work orders with a work order spreadsheet template which can organize work orders by their assigned tracking number, the allocated workers, the requestors, and/or other criteria.

### BRIEF SUMMARY

A data model may enable a work order generating system to generate work orders, which copies fields from the data model's template objects. For example, a work order generating system can generate an automotive maintenance work order by copying the work plan fields in a data model's automotive maintenance work plan template object to create an automotive maintenance work plan with the same work plan fields, and by copying the work step fields in the data model's automotive maintenance work step template object to create automotive maintenance work steps with the same work step fields. However, all of the data model's fields may be standard fields, and in real-world use cases, different enterprises may need additional custom fields to better serve the enterprise's purposes.

For example, an automotive maintenance corporation may generate work plans for changing the oil in a car, selling maintenance packages for a car, and replacing the tires of a car. The automotive maintenance corporation may create a refer-a-friend program which can offer a future discounted oil change price to a car owner who referred another car owner to the automotive maintenance corporation to change the oil in their car. The automotive maintenance corporation may also sell different levels of maintenance packages and offer online discount coupons that can provide a car owner with an incentive to renew an expiring maintenance package. The automotive maintenance corporation may additionally pay a bonus to a field service technician who convinces a car owner to upgrade the pending purchase of a set of new tires to a more expensive set of new tires. However, the standard fields in a data model's work plan template object may not include a “referral” field that the automotive maintenance corporation can use to record the information about a car owner who referred a friend to have their car oil changed, the online discount coupon referenced for the renewal of a maintenance package, or the field service technician who referred a customer to upgrade the pending purchase of a set of new tires.

In accordance with embodiments, there are provided systems and methods for creating work order plans and steps based on mapped fields. A database system receives an input to create a work order, and then identifies a work plan template object, a word plan instance object, a work step template object, and a work step instance object for the work order. The database system identifies work plan fields which are mapped from the work plan template object to the work plan instance object, and work step fields which are mapped from the work step template object to the work step instance object. The database system creates work plans which include the mapped work plan fields in the work plan instance object and work steps which include the mapped work step fields in the work step instance object. The database system outputs the work order which includes the work plans.

For example, a work order generating system receives the input “oil change” and a car's license plate characters “XYZ123,” for creating an automotive maintenance work order for the car. The system uses this input to identify a safety check work plan template object and instance object, a synthetic oil change work plan template object and instance object, and a bronze maintenance package work plan template object and instance object, because safety is required for all work orders and the car's license plate characters “XYZ123” is registered to a Mercedes Benz which requires synthetic oil and is covered by a bronze maintenance package. The safety check work plan template object includes a work step template object for wearing protective glasses and wearing a helmet. The synthetic oil change work plan template object includes a custom “referral” field for recording information about somebody who referred the car owner to change their oil, and a work step template object for using synthetic oil to change the oil and for putting an updated sticker on the car's windshield. The bronze maintenance package work plan template object includes a work step template object for checking the windshield water and checking the tire pressure.

The system identifies the work plan name field which is mapped from each work plan template object to its work plan instance object, the custom “referral” field which is mapped from the oil change work plan template object to the oil change work plan instance object, the work step name field which is mapped from each work step template object to its work step instance object, and an execution order field in a work plan template entry object which is mapped to both the work plan and work step instance objects. The system creates work plans which include the mapped work plan name fields and the mapped execution order fields in the work plan instance objects, the mapped custom work plan “referral” field in the oil change work plan instance object, and work steps which include the mapped work step name fields and the mapped execution order fields in the work step instance objects. The system outputs a work order which names work plans for the safety check, synthetic oil change, and bronze maintenance package, listed in their execution order. The work order also names the work steps of wearing protective glasses, wearing a helmet, changing the synthetic oil, putting an updated sticker on the car's windshield, checking the windshield water, and checking the tire pressure, listed in their execution order. The system outputs the work order that names the work plans' work steps, listed in their execution order, and includes the custom “referral” field, for the customer service representative, who only had to enter “oil change” and the car's license plate characters to automatically generate this correct and comprehensive work order which includes a custom field.

Any of the above embodiments may be used alone or together with one another in any combination. The one or more implementations encompassed within this specification may also include embodiments that are only partially mentioned or alluded to or are not mentioned or alluded to at all in this brief summary or in the abstract. Although various embodiments may have been motivated by various deficiencies with the prior art, which may be discussed or alluded to in one or more places in the specification, the embodiments do not necessarily address any of these deficiencies. In other words, different embodiments may address different deficiencies that may be discussed in the specification. Some embodiments may only partially address some deficiencies or just one deficiency that may be discussed in the specification, and some embodiments may not address any of these deficiencies.

### BRIEF DESCRIPTION OF THE DRAWINGS

In the following drawings like reference numbers are used to refer to like elements. Although the following figures depict various examples, the one or more implementations are not limited to the examples depicted in the figures.

FIG. 1 is an operational flow diagram illustrating a high-level overview of a method 100 for creating work order plans and steps based on mapped fields, in an embodiment;

FIG. 2A, FIG. 2B, and FIG. 2. C depict an example frame 200 of a user interface, an object design 230 for field mapping, and a mapped fields table 260 for creating work order plans and steps based on mapped fields, in an embodiment;

FIG. 3 depicts an example representation of a work order/plan/step data model 300 for creating work order plans and steps based on mapped fields, in an embodiment;

FIG. 4 depicts an example frame 400 of a work order template object for creating work order plans and steps based on mapped fields, in an embodiment;

FIG. 5A and FIG. 5B depict example frames 500 and 530 of lists of work plan template objects and work plan selection rules for creating work order plans and steps based on mapped fields, in an embodiment;

FIG. 6A, FIG. 6B, and FIG. 6C depict example frames 600, 630, and 660 of work plan template objects for creating work order plans and steps based on mapped fields, in an embodiment;

FIG. 7 depicts an example frame 700 of a work order generated by creating work order plans and steps based on mapped fields, in an embodiment;

FIG. 8 illustrates a block diagram of an example of an environment 800 wherein an on-demand database service might be used; and

FIG. 9 illustrates a block diagram of an embodiment 900 of elements of FIG. 8 and various possible interconnections between these elements.

### DETAILED DESCRIPTION

### General Overview

Systems and methods are provided for creating work order plans and steps based on mapped fields. As used herein, the term multi-tenant database system refers to those systems in which various elements of hardware and software of the database system may be shared by one or more customers. For example, a given application server may simultaneously process requests for a great number of customers, and a given database table may store rows for a potentially much greater number of customers.

As used herein, the term query plan refers to a set of steps used to access information in a database system. Next, a method, frames, a data model, and systems for creating work order plans and steps based on mapped fields will be described with reference to example embodiments. The following detailed description will first describe an example method, frames, and a data model for creating work order plans and steps based on mapped fields. Then systems for creating work order plans and steps based on mapped fields are described.

While one or more implementations and techniques are described with reference to an embodiment in which creating work order plans and steps based on mapped fields is implemented in a system having an application server providing a front end for an on-demand database service capable of supporting multiple tenants, the one or more implementations and techniques are not limited to multi-tenant databases nor deployment on application servers. Embodiments may be practiced using other database architectures, i.e., ORACLE®, DB2® by IBM and the like without departing from the scope of the embodiments claimed.

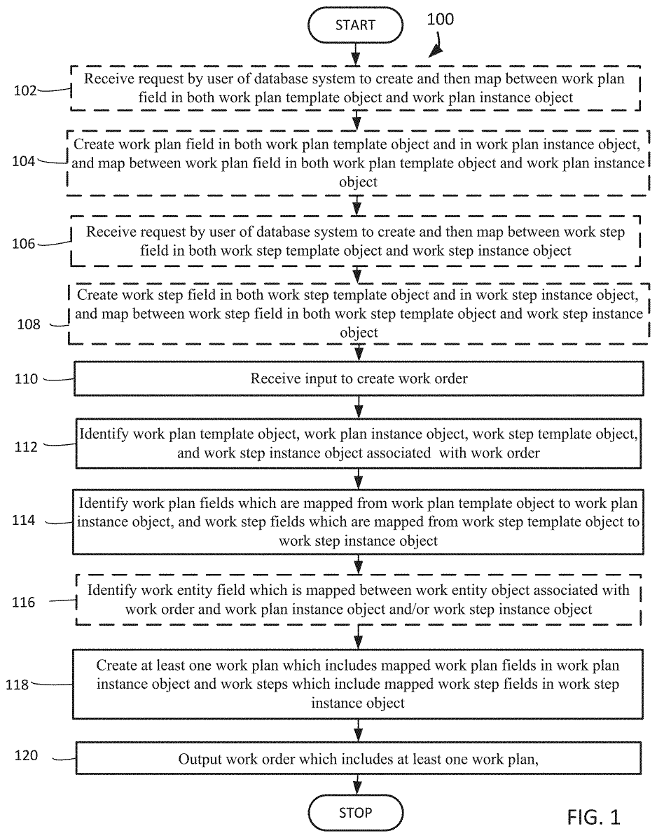

FIG. 1 is an operational flow diagram illustrating a high-level overview of a method 100 for creating work order plans and steps based on mapped fields. A request from a user of a database system is optionally received to create and then map between a work plan field in both a work plan template object and a work plan instance object, block 102. The system enables users to create and map customized work plan fields. For example, and without limitation, this can include a database system, such as a work order generating system, receiving a request from a database system administrator to create a custom “referral” field in both an oil change work plan template object and an oil change work plan instance object, and then map between the custom “referral” fields.

A request can be an instruction to a computer to perform a function. A database system can be computer components that interacts with a user and software applications to capture and analyze the operations performed by a computer, being stored, and transmitted in the form of electrical signals stored on recording media. A work plan field can be a part of a record, representing an item of data, for an outline of a set of goals and processes by which the goals may be accomplished. A work plan template object can be a preset format for an outline of a set of goals and processes by which the goals may be accomplished, which is used so that the format does not have to be recreated each time that such an outline is used. A work plan instance object can be a conceptual representation of information in an outline of a set of goals and processes by which the goals may be accomplished.

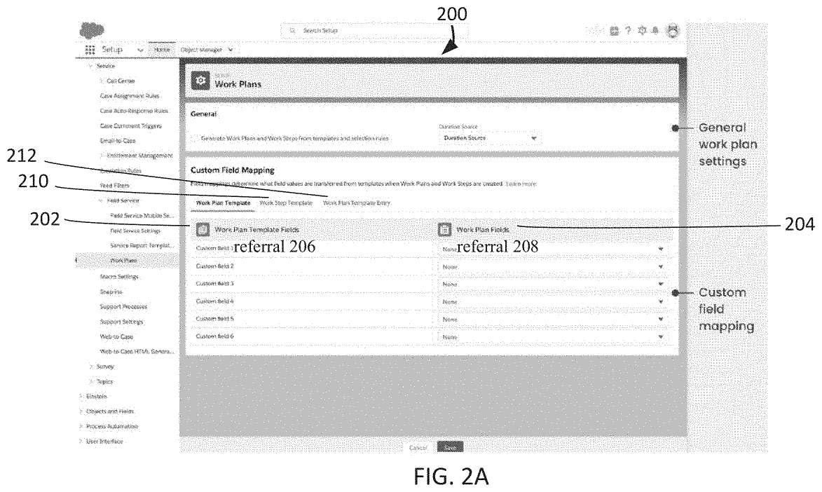

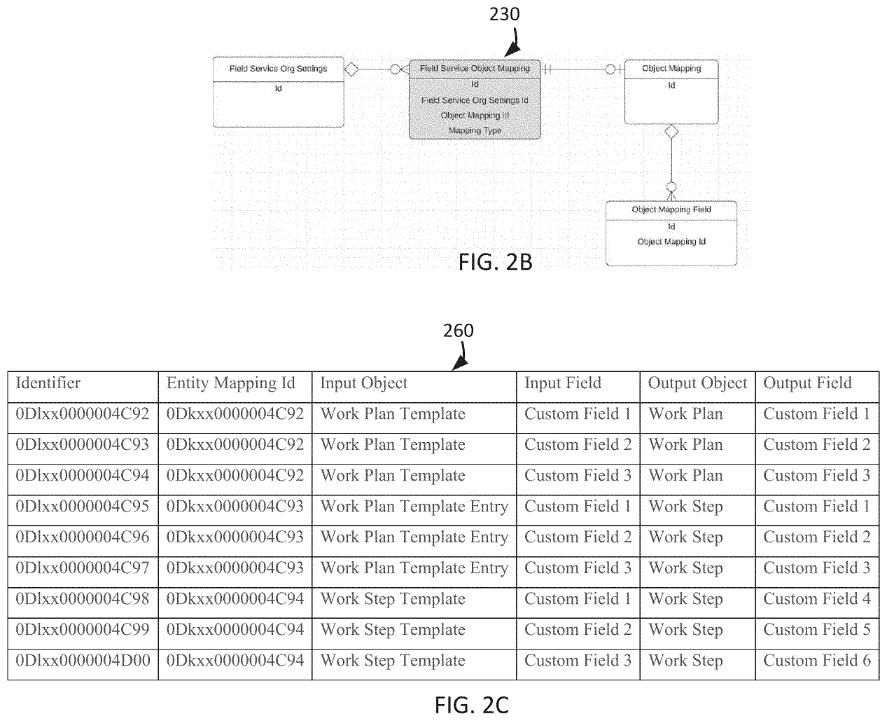

FIG. 2A depicts a frame 200 of an example user interface for field mapping which a database system administrator can use to specify that a work plan template (object) field 202 and a work plan (instance object) field 204 include a newly created pair of custom work plan “referral” fields 206 and 208, and then map between the newly created pair of custom work plan “referral” fields 206 and 208. The frame 200 also depicts that a database system administrator can select a work step template (option) 210 to specify that a work step template (object) field and a work step (instance object) field include a newly created pair of custom fields, and then map between the newly created pair of custom fields. The frame 200 additionally depicts that a database system administrator can select a work plan template entry (option) 212 to specify that a work plan template entry (object) field and a work plan (instance object) field include a newly created pair of custom fields, and then map between the newly created pair of custom fields. The frame 200 enables a user such as a database system administrator to specify which custom fields on the source template objects for work plans, work steps, and work plan entries map to which fields on the target instance objects for work plans, work steps, and work plan entries.

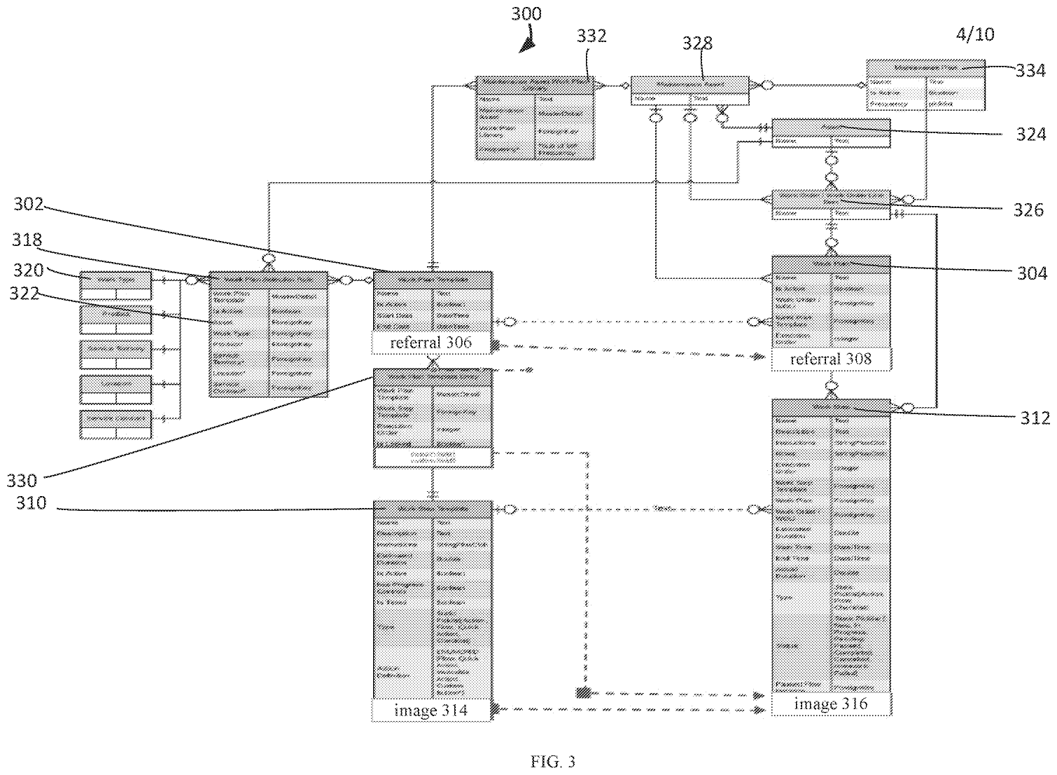

A work plan setup user interface can depict this custom field creation and mapping information, and also store this information during setup to a data model, such as the work order/plan/step data model 300 depicted by FIG. 3. The work order/plan/step data model 300 is generic enough to handle field mapping from any entity to any entity. The work order/plan/step data model 300 may be available via both metadata and tooling Application Programming Interfaces (APIs).

The work order generating system can support 1 to 1 mapping, such that 1 custom field on a source template object maps to 1 custom field on a target instance object. The work order generating system can perform validations when saving this mapping information to the work order/plan/step data model 300, such as validating that the data type of the custom field on the source template object matches the data type of the mapped custom field on the target instance object. If a mapping is defined on custom fields, the work order generating system can prevent deletion of the custom field on an entity.

FIG. 2B depicts an example of object design 230 for field mapping, which may be applied to map pairs of standard fields and/or to map pairs of custom fields, such as map between the newly created pair of custom work plan “referral” fields 206 and 208. As depicted in Table 1 below for this field mapping design, the input object is the source object, such as a work plan template object, and the output object is the target object, such as a work plan instance object. The work order generating system can apply restrictions on field mapping, such as validating the uniqueness of the identifiers specified for mapping the source objects and the target objects.

TABLE 1

| Identifier | Input Object | Output Object |
|---|---|---|
| 0Dkxx0000004C92 | Work Plan Template | Work Plan |
| 0Dkxx0000004C93 | Work Plan Template Entry | Work Step |
| 0Dkxx0000004C94 | Work Step Template | Work Step |

The work order generating system can store multiple records for the mapping depicted above in Table 1. FIG. 2C depicts a table 260 which specifies examples of an input object, which is the parent of the input field, which is mapped to the output field, which is the child of the output object.

Table 2 below depicts that the field mapping may have a junction entity which may be a junction between a field service organization settings and object mapping.

TABLE 2

| | B | C | |
|---|---|---|---|
| | Field Service | Object | |
| A | Organization | Mapping | D |
| Id | Settings Identifier | Identifier | Mapping Type |
| | 0UJxx0000004B81 | 0Dkxx0000004C94 | Work Plans_Work Plan |
| | | | Template_Work Plan |
| | 0UJxx0000004B81 | 0Dkxx0000004C93 | Work Plans_Work Step |
| | | | Template_Work Step |
| | 0UJxx0000004B81 | 0Dkxx0000004C92 | Work Plans_Work Plan |
| | | | Template Entry_Work |
| | | | Step Template |

The Field Service Organization Settings may be part of a Field Service Setting object, which may be exposed to APIs. All of the Create, Read, Update, and Delete (CRUD) operations for the object mapping may be invoked through the Field Service Setting object. An end user would not know or need to know anything about other objects. The field mapping functionality increases the extensibility of the work order/plan/step data model 300, which may be used by different users to meet their business needs.

If a user requests to create and map customized work plan fields, a custom work plan field is optionally created in both a work plan template object and in a work plan instance object, and mapping is optionally created between the custom work plan field in both the work plan template object and the work plan instance object, block 104. The system can create and map customized work plan fields. By way of example and without limitation, this can include the work order generating system creating a pair of custom work plan “referral” fie1ds 306 and 308 in a work plan template (object) 302 and a work plan (instance object) 304, and then mapping between the custom work plan “referral” fields 306 and 308, such as in an oil change work plan template object and an oil change work plan instance object, as depicted in the work order/plan/step data model 300 by FIG. 3.

In addition to a user of a database system optionally requesting to create and map customized work plan fields, a request from the user of the database system is optionally received to create and then map between a work step field in both a work step template object and a work step instance object, block 106. The system enables users to create and map customized work step fields. In embodiments, this can include the work order generating system receiving a request from a database system administrator to create a custom work step “image” field in both a work step template object and a work step instance object, and then map between the custom work step “image” fields.

FIG. 2A depicts a frame 200 of an example user interface which a user such as a database system administrator can use to select a work step template (option) 210 to specify that a work step template (object) field and a work step (instance object) field include a newly created pair of custom work step “image” fields and, and then map between the newly created pair of custom work step “image” fields. For example, a database system administrator can create a custom work step “image” field in both an oil change work step template object and an oil change work step instance object to enable the recording of an image of a car owner's signature authorizing the car owner's credit card company to pay for an oil change. FIG. 2B depicts an example of field service object mapping design 230, which may be applied to map pairs of standard fields and/or to map pairs of custom fields, such as to map between the newly created pair of custom work step “image” fields.

A work step field can be a part of a record, representing an item of data, for an outline of a task to accomplish a goal. A work step template object can be a preset format of an outline of a task to accomplish a goal, which is used so that the format does not have to be recreated each time that such an outline is used. A work step instance object can be a conceptual representations of an outline of a task to accomplish a goal. A work step can be an outline of a task to accomplish a goal.

If a user requests to create and map customized work step fields, a custom work step field is optionally created in both a work step template object and in a work step instance object, and mapping is optionally created between the custom work step field in both the work step template object and the work step instance object, block 108. The system can create and map customized work step fields. For example, and without limitation, this can include a work order generating system creating a custom work step “image” field 314 and a custom work step “image” field 316 in a corresponding work step template (object) 310 and a work step (instance object) 312, respectively, and then mapping between the custom work step “image” field 314 and the custom work step “image” field 316, as depicted in the work order/plan/step data model 300 by FIG. 3.

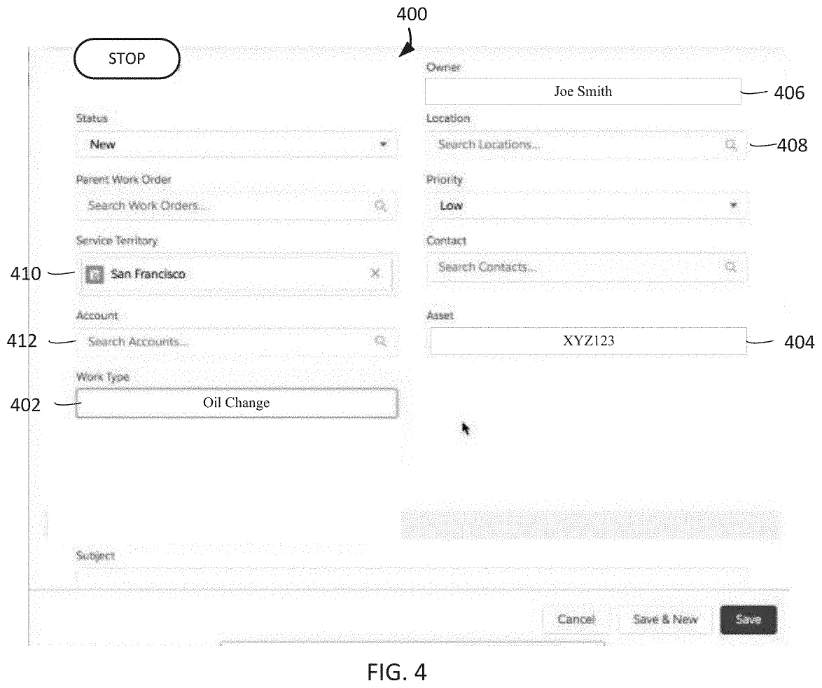

In addition to creating any custom fields, an input to create a work order is received, block 110. The system receives a user's input for creating a work order. By way of example and without limitation, this can include the work order generating system receiving the inputs “oil change” in the work type field 402, a car's license plate characters “XYZ123” in the asset field 404, and “Joe Smith,” the name of the customer service representative who is creating a work order for the car, in the owner field 406, as depicted in the work order template frame 400 by FIG. 4. This example describes how some inputs may be entered via a pick list, such as the “oil change” work type, and other inputs may be entered via a free form field, such as the car's license plate characters “XYZ123.”

An input can be information that enters a system. A work type can be a category of an activity to achieve a goal, especially related to a job. An asset can be property regarded as having value.

Although this example describes the input for creating the work order as being received from a system user, the input for creating the work order may be received from a software application that generates the input based on a maintenance plan. For example, every six months a maintenance plan application inputs “tire rotation” in the work type field 402 and the car's license plate characters “XYZ123” in the asset field 404 to generate a work order for rotating the car's tires.

A system user can be a person who operates a computer. A software application can be a computer program designed to perform a group of coordinated activities. A maintenance plan can be a physical or electronic document that defines work done to keep an asset in working condition by checking and repairing the asset regularly.

The frame 400 also includes a location field 408, a service territory field 410, and an (customer) account field 412, in which a system user can enter inputs for creating a work order. Although not depicted by FIG. 4, the frame 400 can also include fields for the user to input information for a product, a service contract, and any other information that may be input for creating a work order.

A location can be a particular place. A service territory can be a geographical area where work is done. A customer account can be a business relationship with the buyer or lease owner of a product or a service. A product can be an article that is manufactured for sale. A service contract can be a business agreement with a customer covering the maintenance of equipment over a specified time period.

Having received an input for creating a work order, a work plan template object, a work plan instance object, a work step template object, and a work step instance object associated with a work order are identified, block 112. The system selects work plan and work step template objects and instance objects to create a work order. In embodiments, this can include the work order generating system referencing a table of work plan selection rules 318 to determine that the “oil change” input directly identifies a work type 320 of an oil change in the work plan selection rules 318, and that the car's license plate characters “XYZ123” directly identifies an asset 322 of a car in the work plan selection rules 318, as depicted in the work order/plan/step data model 300 by FIG. 3.

Since the asset 322 in the work plan selection rules 318 includes a foreign key for a table of assets 324, the work order generating system uses this identified car asset 322 to indirectly identify the car owner's service contract as a bronze service contract in the asset table 324, as depicted in the work order/plan/step data model 300 by FIG. 3. In a contrasting example, the work order generating system did not directly or indirectly apply any work plan selection rules 318 to the input of “Joe Smith,” the name of the customer service representative. A work plan selection rule can be a standard for deciding which information corresponds to an outline of a set of goals and processes by which the goals may be accomplished.

The work order generating system enables customers to customize features and add custom features to extend the “out of the box” capabilities of the work order/plan/step data model 300, which can store mappings between standard fields as parts of configuration files, which are described as follows. The work plan selection rules 318 includes foreign keys for an asset 322, a work type 320, a product, a service territory, a location, and a service contract, and a relationship to the work plan template (object) 302. The asset table 324 includes relationships to a table of work orders/work order line-items 326 and a table of maintenance assets 328. The work plan template (object) 302 has relationships to the work plan selection rules 318, to a work plan template entry (object) 330, to the work plan (instance object) 304, and to a library of maintenance assets—work plans 332.

The work order/work order line-item table 326 includes relationships to the asset table 324, the maintenance asset table 328, the work plan (instance object) 304, the work step (instance object) 312, and a table of maintenance plans 334. The maintenance asset table 328 includes relationships to the asset table 324, the maintenance asset—work plan library 332, and the maintenance plan table 334. The work plan template entry (object) 330 associates the work plan template (object) 302 with the work step template (object) 310. The work plan (instance object) 304 includes relationships to the work plan template (object) 302, the work order/work order line-item table 326, the maintenance asset table 328, and the work step (instance object) 312.

The maintenance asset - work plan library 332 includes relationships to the work plan template (object) 302 and the maintenance asset table 328. The work step (instance object) 312 includes relationships to the work order/work order line-item table 326, the work plan (instance object) 304; and the work step template (object) 310. The maintenance plan table 334 includes relationships to the work order/work order line-item table 326 and the maintenance asset table 328. The work step template (object) 310 includes work step template objects and relationships to the work plan template entry (object) 330, and the work step (instance object) 312.

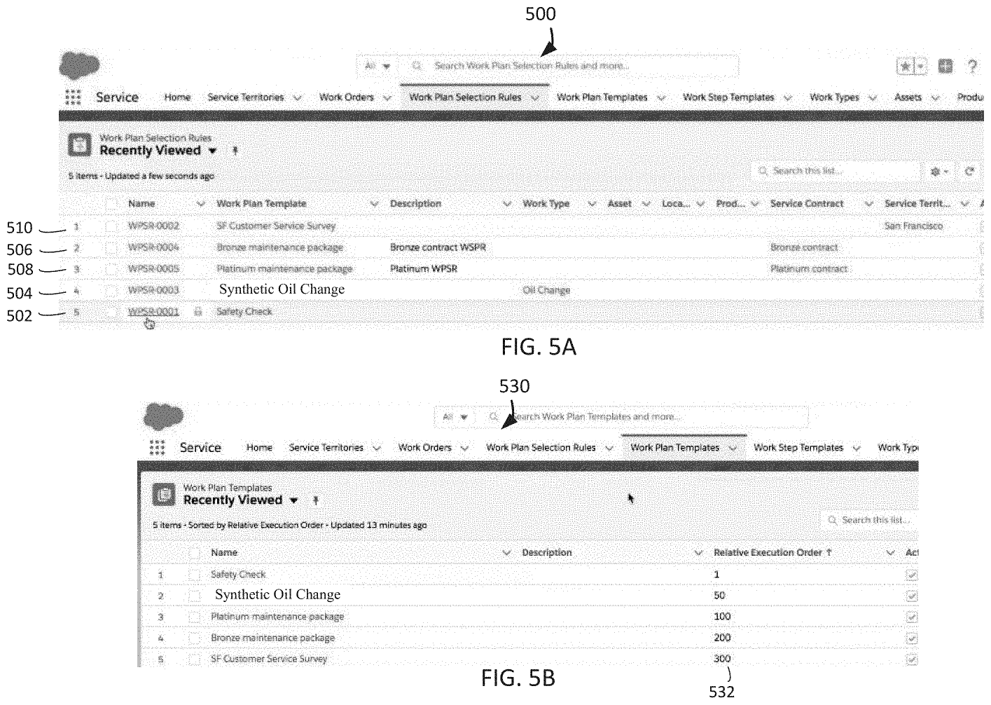

The work order generating system can apply the work plan selection rules 318, including a rule 502 that generates a safety check work plan template object from the work plan template (object) 302 for all work orders, as depicted in the frame 500 by FIG. 5. The work plan selection rules 318 also includes a rule 504 that generates an oil change work plan template object from the work plan template (object) 302 for the oil change work type 320, as depicted in the frame 500 by FIG. 5. The work plan selection rules 318 further includes a rule 506 that generates a bronze maintenance package work plan template object from the work plan template (object) 302 for the car owner's bronze service contract in the asset table 324, as depicted in the frame 500 by FIG. 5. For this example, the work plan selection rules 318 did not apply the rule 508 that selects a platinum maintenance package because the work plan selection rules 318 applied to the asset table 324 specified a bronze maintenance package, and also did not apply the rule 510 that selects a San Francisco customer service survey because the work plan selection rules 318 did not identify San Francisco as the location.

While the work plan selection rule 504 could be the equivalent of “if the work type equals oil change, then select an oil change work plan template object,” the work plan selection rules may be more complex and use logical ANDs and/or logical ORs. For example, an additional work plan selection rule that could be executed after rule 506 could be the equivalent of “if a service contract equals bronze AND the service contract expires in less than 30 days, then temporary upgrade the customer by selecting a platinum maintenance package work plan template object,” which offers an incentive for the car owner to consider upgrading their service contract upon renewal.

The frame 530 depicts the six work plan template objects that correspond to the rules 502-510 in the frame 500, with the six work plan template objects listed according to their relative execution order 532. Although the frame 500 depicts five automotive maintenance work plan selection rules for six automotive maintenance work plan template objects and the frame 530 depicts six automotive maintenance work plan template objects, the work order generating system can create and use any numbers of any types of work plan selection rules to select from any numbers of any types of work plan template objects. For example, the work order generating system can create and use monthly, quarterly, and annual work plan selection rules to select work plan template objects for high performance process manager maintenance, general data and safety, software and backup, controller inspection, and final inspection.

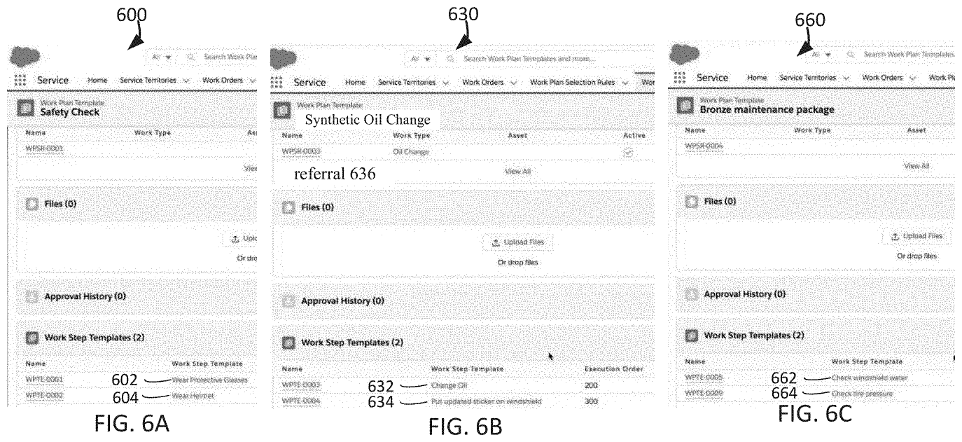

FIG. 6A depicts that the safety check work plan template (object) 600 generated from the work plan template (object) 302 may include work step template objects generated from the work step template (object) 310, such as work steps for wearing protective glasses 602 and wearing a helmet 604. FIG. 6B depicts that the oil change work plan template (object) 630 generated from the work plan template (object) 302 may include work step template objects generated from the work step template (object) 310, such as work steps for changing the oil 632 and putting an updated sticker on the car's windshield 634, and a custom field for “referral” 636, which is also generated from the work plan template (object) 302. FIG. 6C depicts that the bronze maintenance package work plan template (object) 660 generated from the work plan template (object) 302 may include work step template objects generated from the work step template (object) 310, such as work steps for checking the windshield water 662 and checking the tire pressure 664. The work plan template entry (object) 330 that associates the work plan template (object) 302 with the work step template (object) 310 enables these work plan template objects to include these work step template objects.

Although these example work plan template objects 600, 630, and 660 include work step template objects 602, 604, 632, 634, 636, 662, and 664, respectively, the reusable work plan template objects do not require reusable work step template objects because every work step may be recreated each time that such a work step is required for the reusable work plan template objects. Due to the modularity and efficiency of reusable template objects, the work order generating system may reference reusable work step template objects, instead of newly recreating work steps, in the reusable work plan template objects, and can reference the same reusable work step template object in many different reusable work plan template objects.

Although the frames 600 630, and 660 depict six automotive maintenance work steps for three automotive maintenance work plan template objects, the work order generating system can provide any numbers of any types of work steps for any numbers of any types of work plan template objects, such as the work steps for high performance process manager maintenance. Such work steps could include (in execution order) checking and cleaning fans and filters, checking card status indicators, checking communication and control CPU free to ensure they meet minimum requirements for a node, checking for excessive processing overruns and recommending actions to correct a problem, checking power supply statuses, checking the alarm system (power supply, battery) if not disabled, checking the I/O link bandwidth free and ensure they meet minimum requirements, checking the I/O link communication statistics, resetting the I/O link communication statistics, and resetting UCN communication statistics.

After identifying a work order's work plan and step template objects and work plan and step instance objects, the work plan fields which are mapped from a work plan template object to a work plan instance object are identified, and the work step fields which are mapped from a work step template object to a work step instance object are identified, block 114. The system identifies the work plan and work step template objects' fields which are mapped to their corresponding instance objects' fields. For example, and without limitation, this can include the work order generating system identifying that the work plan fields for “name,” “is active,” and “referral” in the work plan template (object) 302 are mapped to the corresponding work plan fields for “name,” “is active,” and “referral” in the work plan (instance object) 304. In another example, the work order generating system identifies that the work step fields for “name” “description,” ‘instructions,” “estimated duration,” “type,” and “image”” in the work step template (object) 310 are mapped to the corresponding work step fields for “name” “description,” ‘instructions,” “estimated duration,” “type,” and “image” in the work step (instance object) 312.

While identifying mapped fields in the work plan instance object and/or the work step instance object, a work entity field is optionally identified which is mapped between a work entity object associated with the work order and the work plan instance object and/or the work step instance object, block 116. The system can identify other mapped fields to create work order plans and steps. By way of example and without limitation, this can include the work order generating system identifying that the field for “execution order” in the work plan template entry (object) 330 is mapped to the corresponding field for “execution order” in both the work plan (instance object) 304 and the work step (instance object) 312.

A work entity field can be a part of a record, representing an item of data, for an outline of a set of goals or a task and processes by which the goals or task may be accomplished. A work entity object can be a conceptual representation for an outline of a set of goals or a task and processes by which the goals or task may be accomplished. A mapped work entity field can be a part of a record, representing an item of data, for an outline of a set of goals or a task and processes by which the goals or task may be accomplished, and which is associated with a corresponding and equivalent outline. An execution order can be the sequence for carrying out or putting into effect a plan or course of actions.

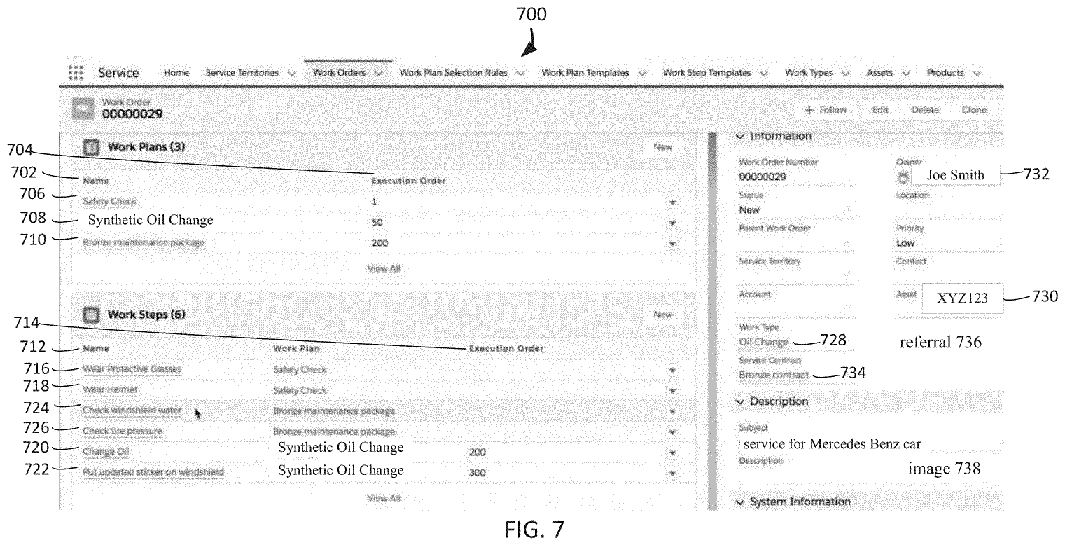

Following the identification of mapped fields, at least one work plan is created which includes the mapped work plan fields in a work plan instance object and work steps which includes the mapped work step fields in a work step instance object, block 118. The system creates work order plans and steps based on mapped fields. In embodiments, this can include the work order generating system generating the rule-selected work plans for the safety check 706, synthetic oil change 708, and bronze maintenance package 710, with these work plans' names and execution orders listed under the work plan “name” field 702 and the work plan “execution order” field 704, as depicted in the frame 700 by FIG. 7. The work order generating system generated the work plan “name” field 702 and the work plan “execution order” field 704 for the selected work plans because the work plan (instance object) 304 includes both the “name” field mapped from the work plan template (object) 302 and the “execution order” field mapped from the work plan template entry (object) 330.

A work plan can be an outline of a set of goals and processes by which those goals may be accomplished. A mapped work plan field can be a part of a record, representing an item of data, for an outline of a set of goals and processes by which the goals may be accomplished, and which is associated with a corresponding and equivalent outline. A work step can be an outline of a task for a goal to be accomplished. A mapped work step field can be a part of a record, representing an item of data, for an outline of a task for a goal to be accomplished, and which is associated with a corresponding and equivalent outline.

Continuing the example, the work order generating system generates the selected work plans' work steps, which include wearing protective glasses 716, wearing a helmet 718, changing the oil 720, putting an updated sticker on the car's windshield 722, checking the windshield water 724, and checking the tire pressure 726, with these work steps' names and execution orders listed under the work step “name” field 712 and the work step “execution order” field 714, as depicted in the frame 700 by FIG. 7. The work order generating system generated the work step “name” field 712 and the work step “execution order” field 714 for the selected work plans' work steps because the work step (instance object) 312 includes both the “name” field mapped from the work step template (object) 310 and the “execution order” field mapped from the work plan template entry (object) 330.

The work order includes the custom work plan field for “referral” 736 for the oil change work plan instance object to enable the recording of information about somebody who referred the car owner to change their oil, as depicted in the frame 700 by FIG. 7. The work order also includes the custom work step field “image” 738 for the oil change work step instance object to enable the recording of an image of a car owner's signature authorizing the car owner's credit card company to pay for an oil change, as depicted in the frame 700 by FIG. 7. The work order generating system generated the custom work plan field for “referral” 736 for the oil change work plan and the custom work step field “image” 738 for the oil change work step because the work plan (instance object) 304 includes the custom work plan “referral” field mapped from the work plan template (object) 302 and the work step (instance object) 312 includes the custom work step “image” field mapped from the work step template (object) 310.

In contrast, the work order generating system did not generate the work plan template object “start date” field or the work plan template object “stop date” field for the selected work plans because the work plan (instance object) 304 does not include either the “start date” field or the “stop date” work plan fields, since these work plan fields were not mapped from the “start date” field or the “stop date” field in the work plan template (object) 302. Instead, the work order generating system can leverage any transformations that a database system enables to transform data from a source field to a target field because the work order/plan/step data model 300 is extensible and can store customized functions, which enables such custom transformations. For example, the work order generating system generates the work step “start time” field and the work step “stop time” field for the selected work plans' work steps because the work step (instance object) 312 includes both the “start time” field and the “stop time” field, since these fields were mapped and custom transformed from the “start date” field and the “stop date” field in the work plan template (object) 302. A start time can be a chronological beginning of an activity, while a stop time can be a chronological ending of an activity. The work order generating system also did not generate the work step template object fields for “is Active,” “has Progress Controls,” and “is Timed” for the selected work plans' work steps because the work step (instance object) 312 does not include work step fields for “is Active,” “has Progress Controls,” and “is Timed” since these work step fields were not mapped from the “is Active,” “has Progress Controls,” and “is Timed” fields in the work step template (object) 304.

The work order generating system can generate the work step fields for “notes,” “status,” and “paused flow instance” as derived work steps for the selected work plans' work steps because the work step template (object) 304 does not include work step template object fields for “notes,” “status,” and “paused flow instance.” The values of such derivative fields are inferred from the other work step fields in the work step (instance object) 312. For example, a field service technician executes an Action Definition (in an Action Definition field in a work step) which launches a flow of multiple steps, decides to pause the flow to do something else during the execution of the steps, and therefore marks the flow as “paused.” The work order generating system updates the work step “status” field to “paused,” and also associates the identifier of the paused flow with the work step “pause flow instance” field. The field service technician can also enter information in the work step “note” field to indicate why the flow needed to be paused.

Although not depicted in the frame 700 by FIG. 7, the work order further includes the work step fields for “description,” ‘instructions,” “estimated duration,” and “type,” because the work step (instance object) 312 includes these fields which are mapped from the work step template (object) 310. The work order additionally includes the inputs “oil change” 728, the car's license plate characters “XYZ123” 730, the name of the customer service representative “Joe Smith” 732, and the derived information “bronze contract” 734, as further depicted in the frame 700 by FIG. 7.

After creating at least one work plan for a work order, the work order, which includes the at least one work plan, is output, block 120. The system outputs work order plans and steps which were created based on mapped fields. For example, and without limitation, this can include the work order generating system outputting a work order which names the work plans for the safety check 706, synthetic oil change 708, and bronze maintenance package 710, listed in their execution order, to the mobile device of the customer service representative, Joe Smith, as depicted in the frame 700 by FIG. 7. The work order also names the work steps of wearing protective glasses 716, wearing a helmet 718, changing the synthetic oil 720, putting an updated sticker on the car's windshield 722, checking the windshield water 724, and checking the tire pressure 726, listed in their execution order, as depicted in the frame 700 by FIG. 7. The customer service representative only had to enter “oil change” and the car's license plate characters to automatically generate this correct and comprehensive work order.

Although this example describes a work order for a single asset, the work order may include work order line-items that each correspond to a different asset. For example, an application may use a large organization's maintenance plan, from the maintenance plan table 334, to generate a single work order which schedules a large number of cars, which are identified in the maintenance asset table 328, for an oil change within the same time period,

The frames 200, 400, 500, 530, 600, 630, 660, and/or 700 may be parts of larger display screens that include fields for users to enter commands to create, retrieve, edit, and store information. Because the frames 200, 400, 500, 530, 600, 630, 660, and/or 700 are samples, the frames 200, 400, 500, 530, 600, 630, 660, and/or 700 could vary greatly in appearance. For example, the relative sizes and positioning of the graphical images are not important to the practice of the present disclosure. The frames 200, 400, 500, 530, 600, 630, 660, and/or 700 may be depicted by any visual display, but they are preferably depicted by a computer screen. The frames 200, 400, 500, 530, 600, 630, 660, and/or 700 could also be output as reports and printed or saved in electronic formats, such as the PDF format.

The frames 200, 400, 500, 530, 600, 630, 660, and/or 700 may be parts of a personal computer system and/or a network, and operated from system data received by the network, and/or on the Internet. The frames 200, 400, 500, 530, 600, 630, 660, and/or 700 may be navigable by a user. Typically, a user can employ a touch screen input, voice command, or a mouse input device to point-and-click to locations on the frames 200, 400, 500, 530, 600, 630, 660, and/or 700 to manage the graphical images on the frames 200, 400, 500, 530, 600, 630, 660, and/or 700.

Alternately, a user can employ directional indicators, or other input devices such as a keyboard. The graphical images depicted by the frames 200, 400, 500, 530, 600, 630, 660, and/or 700 are examples, as the frames 200, 400, 500, 530, 600, 630, 660, and/or 700 may include much greater amounts of graphical images. The frames 200, 400, 500, 530, 600, 630, 660, and/or 700 may also include fields in which a user can input information.

The method 100 may be repeated as desired. Although this disclosure describes the blocks 102-120 executing in a particular order, the blocks 102-120 may be executed in a different order. In other implementations, each of the blocks 102-120 may also be executed in combination with other blocks and/or some blocks may be divided into a different set of blocks.

### System Overview

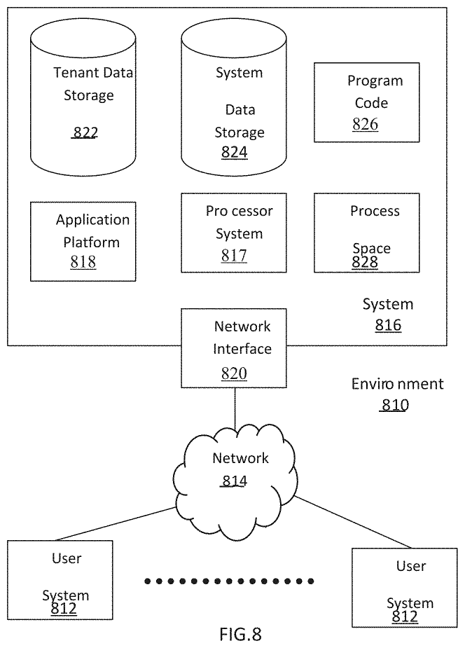

FIG. 8 illustrates a block diagram of an environment 810 wherein an on-demand database service might be used. The environment 810 may include user systems 812, a network 814, a system 816, a processor system 817, an application platform 818, a network interface 820, a tenant data storage 822, a system data storage 824, program code 826, and a process space 828. In other embodiments, the environment 810 may not have all of the components listed and/or may have other elements instead of, or in addition to, those listed above.

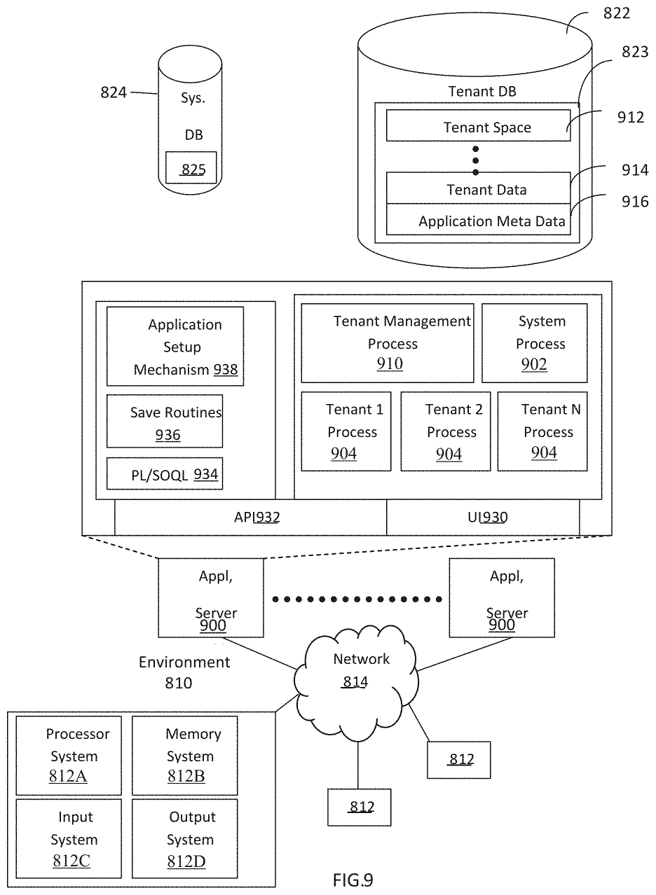

The environment 810 is an environment in which an on-demand database service exists. A user system 812 may be any machine or system that is used by a user to access a database user system. For example, any of the user systems 812 may be a handheld computing device, a mobile phone, a laptop computer, a work-station, and/or a network of computing devices. As illustrated in FIG. 8 (and in more detail in FIG. 9) the user systems 812 might interact via the network 814 with an on-demand database service, which is the system 816.

An on-demand database service, such as the system 816, is a database system that is made available to outside users that do not need to necessarily be concerned with building and/or maintaining the database system, but instead may be available for their use when the users need the database system (e.g., on the demand of the users). Some on-demand database services may store information from one or more tenants stored into tables of a common database image to form a multi-tenant database system (MTS). Accordingly, the “on-demand database service 816” and the “system 816” will be used interchangeably herein.

A database image may include one or more database objects. A relational database management system (RDMS) or the equivalent may execute storage and retrieval of information against the database object(s). The application platform 818 may be a framework that allows the applications of the system 816 to run, such as the hardware and/or software, e.g., the operating system. In an embodiment, the on-demand database service 816 may include the application platform 818 which enables creation, managing and executing one or more applications developed by the provider of the on-demand database service, users accessing the on-demand database service via user systems 812, or third-party application developers accessing the on-demand database service via the user systems 812.

The users of the user systems 812 may differ in their respective capacities, and the capacity of a particular user system 812 might be entirely determined by permissions (permission levels) for the current user. For example, where a salesperson is using a particular user system 812 to interact with the system 816, that user system 812 has the capacities allotted to that salesperson. However, while an administrator is using that user system 812 to interact with the system 816, that user system 812 has the capacities allotted to that administrator. In systems with a hierarchical role model, users at one permission level may have access to applications, data, and database information accessible by a lower permission level user, but may not have access to certain applications, database information, and data accessible by a user at a higher permission level. Thus, different users will have different capabilities with regard to accessing and modifying application and database information, depending on a user's security or permission level.

The network 814 is any network or combination of networks of devices that communicate with one another. For example, the network 814 may be any one or any combination of a LAN (local area network), WAN (wide area network), telephone network, wireless network, point-to-point network, star network, token ring network, hub network, or other appropriate configuration. As the most common type of computer network in current use is a TCP/IP (Transfer Control Protocol and Internet Protocol) network, such as the global internetwork of networks often referred to as the “Internet” with a capital “I,” that network will be used in many of the examples herein. However, it should be understood that the networks that the one or more implementations might use are not so limited, although TCP/IP is a frequently implemented protocol.

The user systems 812 might communicate with the system 816 using TCP/IP and, at a higher network level, use other common Internet protocols to communicate, such as HTTP, FTP, AFS, WAP, etc. In an example where HTTP is used, the user systems 812 might include an HTTP client commonly referred to as a “browser” for sending and receiving HTTP messages to and from an HTTP server at the system 816. Such an HTTP server might be implemented as the sole network interface between the system 816 and the network 814, but other techniques might be used as well or instead. In some implementations, the interface between the system 816 and the network 814 includes load sharing functionality, such as round-robin HTTP request distributors to balance loads and distribute incoming HTTP requests evenly over a plurality of servers. At least as for the users that are accessing that server, each of the plurality of servers has access to the MTS' data; however, other alternative configurations may be used instead.

In one embodiment, the system 816, shown in FIG. 8, implements a web-based customer relationship management (CRM) system. For example, in one embodiment, the system 816 includes application servers configured to implement and execute CRM software applications as well as provide related data, code, forms, webpages and other information to and from the user systems 812 and to store to, and retrieve from, a database system related data, objects, and Webpage content. With a multi-tenant system, data for multiple tenants may be stored in the same physical database object, however, tenant data typically is arranged so that data of one tenant is kept logically separate from that of other tenants so that one tenant does not have access to another tenant's data, unless such data is expressly shared.

In certain embodiments, the system 816 implements applications other than, or in addition to, a CRM application. For example, the system 816 may provide tenant access to multiple hosted (standard and custom) applications, including a CRM application. User (or third-party developer) applications, which may or may not include CRM, may be supported by the application platform 818, which manages creation, storage of the applications into one or more database objects and executing of the applications in a virtual machine in the process space of the system 816.

One arrangement for elements of the system 816 is shown in FIG. 8, including the network interface 820, the application platform 818, the tenant data storage 822 for tenant data 823, the system data storage 824 for system data 825 accessible to the system 816 and possibly multiple tenants, the program code 826 for implementing various functions of the system 816, and the process space 828 for executing MTS system processes and tenant-specific processes, such as running applications as part of an application hosting service. Additional processes that may execute on the system 816 include database indexing processes.

Several elements in the system shown in FIG. 8 include conventional, well-known elements that are explained only briefly here. For example, each of the user systems 812 could include a desktop personal computer, workstation, laptop, PDA, cell phone, or any wireless access protocol (WAP) enabled device or any other computing device capable of interfacing directly or indirectly to the Internet or other network connection. Each of the user systems 812 typically runs an HTTP client, e.g., a browsing program, such as Microsoft's Internet Explorer browser, Netscape's Navigator browser, Opera's browser, or a WAP-enabled browser in the case of a cell phone, PDA or other wireless device, or the like, allowing a user (e.g., subscriber of the multi-tenant database system) of the user systems 812 to access, process and view information, pages and applications available to it from the system 816 over the network 814.

Each of the user systems 812 also typically includes one or more user interface devices, such as a keyboard, a mouse, trackball, touch pad, touch screen, pen, or the like, for interacting with a graphical user interface (GUI) provided by the browser on a display (e.g., a monitor screen, LCD display, etc.) in conjunction with pages, forms, applications, and other information provided by the system 816 or other systems or servers. For example, the user interface device may be used to access data and applications hosted by the system 816, and to perform searches on stored data, and otherwise allow a user to interact with various GUI pages that may be presented to a user. As discussed above, embodiments are suitable for use with the Internet, which refers to a specific global internetwork of networks. However, it should be understood that other networks may be used instead of the Internet, such as an intranet, an extranet, a virtual private network (VPN), a non-TCP/IP based network, any LAN or WAN or the like.

According to one embodiment, each of the user systems 812 and all of its components are operator configurable using applications, such as a browser, including computer code run using a central processing unit such as an Intel Pentium® processor or the like. Similarly, the system 816 (and additional instances of an MTS, where more than one is present) and all of their components might be operator configurable using application(s) including computer code to run using a central processing unit such as the processor system 817, which may include an Intel Pentium® processor or the like, and/or multiple processor units. A computer program product embodiment includes a machine-readable storage medium (media) having instructions stored thereon/in which may be used to program a computer to perform any of the processes of the embodiments described herein. Computer code for operating and configuring the system 816 to intercommunicate and to process webpages, applications and other data and media content as described herein are preferably downloaded and stored on a hard disk, but the entire program code, or portions thereof, may also be stored in any other volatile or non-volatile memory medium or device as is well known, such as a ROM or RAM, or provided on any media capable of storing program code, such as any type of rotating media including floppy disks, optical discs, digital versatile disk (DVD), compact disk (CD), micro-drive, and magneto-optical disks, and magnetic or optical cards, nano-systems (including molecular memory ICs), or any type of media or device suitable for storing instructions and/or data.

Additionally, the entire program code, or portions thereof, may be transmitted and downloaded from a software source over a transmission medium, e.g., over the Internet, or from another server, as is well known, or transmitted over any other conventional network connection as is well known (e.g., extranet, VPN, LAN, etc.) using any communication medium and protocols (e.g., TCP/IP, HTTP, HTTPS, Ethernet, etc.) as are well known. It will also be appreciated that computer code for implementing embodiments may be implemented in any programming language that may be executed on a client system and/or server or server system such as, for example, C, C++, HTML, any other markup language, Java™, JavaScript, ActiveX, any other scripting language, such as VBScript, and many other programming languages as are well known may be used. (Java™ is a trademark of Sun Microsystems, Inc.).

According to one embodiment, the system 816 is configured to provide webpages, forms, applications, data, and media content to the user (client) systems 812 to support the access by the user systems 812 as tenants of the system 816. As such, the system 816 provides security mechanisms to keep each tenant's data separate unless the data is shared. If more than one MTS is used, they may be located in close proximity to one another (e.g., in a server farm located in a single building or campus), or they may be distributed at locations remote from one another (e.g., one or more servers located in city A and one or more servers located in city B). As used herein, each MTS could include one or more logically and/or physically connected servers distributed locally or across one or more geographic locations.

Additionally, the term “server” is meant to include a computer system, including processing hardware and process space(s), and an associated storage system and database application (e.g., OODBMS or RDBMS) as is well known in the art. It should also be understood that “server system” and “server” are often used interchangeably herein. Similarly, the database object described herein may be implemented as single databases, a distributed database, a collection of distributed databases, a database with redundant online or offline backups or other redundancies, etc., and might include a distributed database or storage network and associated processing intelligence.

FIG. 9 also illustrates the environment 810. However, in FIG. 9 elements of the system 816 and various interconnections in an embodiment are further illustrated. FIG. 9 shows that the each of the user systems 812 may include a processor system 812A, a memory system 812B, an input system 812C, and an output system 812D.

FIG. 9 shows the network 814 and the system 816. FIG. 9 also shows that the system 816 may include the tenant data storage 822, the tenant data 823, the system data storage 824, the system data 825, a User Interface (UI) 930, an Application Program Interface (API) 932, a PL/SOQL 934, save routines 936, an application setup mechanism 938, applications servers 900₁-900_{N}, a system process space 902, tenant process spaces 904, a tenant management process space 910, a tenant storage area 912, a user storage 914, and application metadata 916. In other embodiments, the environment 810 may not have the same elements as those listed above and/or may have other elements instead of, or in addition to, those listed above.

The user systems 812, the network 814, the system 816, the tenant data storage 822, and the system data storage 824 were discussed above in FIG. 8. Regarding the user systems 812, the processor system 812A may be any combination of one or more processors. The memory system 812B may be any combination of one or more memory devices, short-term, and/or long-term memory. The input system 812C may be any combination of input devices, such as one or more keyboards, mice, trackballs, scanners, cameras, and/or interfaces to networks. The output system 812D may be any combination of output devices, such as one or more monitors, printers, and/or interfaces to networks.

As shown by FIG. 9, the system 816 may include the network interface 820 (of FIG. 8) implemented as a set of HTTP application servers 900, the application platform 818, the tenant data storage 822, and the system data storage 824. Also shown is the system process space 902, including individual tenant process spaces 904 and the tenant management process space 910. Each application server 900 may be configured to access tenant data storage 822 and the tenant data 823 therein, and the system data storage 824 and the system data 825 therein to serve requests of the user systems 812. The tenant data 823 might be divided into individual tenant storage areas 912, which may be either a physical arrangement and/or a logical arrangement of data.

Within each tenant storage area 912, the user storage 914 and the application metadata 916 might be similarly allocated for each user. For example, a copy of a user's most recently used (MRU) items might be stored to the user storage 914. Similarly, a copy of MRU items for an entire organization that is a tenant might be stored to the tenant storage area 912. The UI 930 provides a user interface, and the API 932 provides an application programmer interface to the system 816 resident processes to users and/or developers at the user systems 812. The tenant data and the system data may be stored in various databases, such as one or more Oracle™ databases.

The application platform 818 includes the application setup mechanism 938 that supports application developers' creation and management of applications, which may be saved as metadata into the tenant data storage 822 by the save routines 936 for execution by subscribers as one or more tenant process spaces 904 managed by the tenant management process 910 for example. Invocations to such applications may be coded using the PL/SOQL 934 that provides a programming language style interface extension to the API 932. A detailed description of some PL/SOQL language embodiments is discussed in commonly owned U.S. Pat. No. 7,730,478 entitled, METHOD AND SYSTEM FOR ALLOWING ACCESS TO DEVELOPED APPLICATIONS VIA A MULTI-TENANT ON-DEMAND DATABASE SERVICE, by Craig Weissman, filed Sep. 21, 2007, which is incorporated in its entirety herein for all purposes. Invocations to applications may be detected by one or more system processes, which manages retrieving the application metadata 916 for the subscriber making the invocation and executing the metadata as an application in a virtual machine.

Each application server 900 may be communicably coupled to database systems, e.g., having access to the system data 825 and the tenant data 823, via a different network connection. For example, one application server 900₁ might be coupled via the network 814 (e.g., the Internet), another application server 900_{N-1} might be coupled via a direct network link, and another application server 900_{N} might be coupled by yet a different network connection. Transfer Control Protocol and Internet Protocol (TCP/IP) are typical protocols for communicating between application servers 900 and the database system. However, it will be apparent to one skilled in the art that other transport protocols may be used to optimize the system depending on the network interconnect used.

In certain embodiments, each application server 900 is configured to handle requests for any user associated with any organization that is a tenant. Because it is desirable to be able to add and remove application servers from the server pool at any time for any reason, there is preferably no server affinity for a user and/or organization to a specific application server 900. In one embodiment, therefore, an interface system implementing a load balancing function (e.g., an F5 Big-IP load balancer) is communicably coupled between the application servers 900 and the user systems 812 to distribute requests to the application servers 900.

In one embodiment, the load balancer uses a least connections algorithm to route user requests to the application servers 900. Other examples of load balancing algorithms, such as round robin and observed response time, also may be used. For example, in certain embodiments, three consecutive requests from the same user could hit three different application servers 900, and three requests from different users could hit the same application server 900. In this manner, the system 816 is multi-tenant, wherein the system 816 handles storage of, and access to, different objects, data and applications across disparate users and organizations.

As an example of storage, one tenant might be a company that employs a sales force where each salesperson uses the system 816 to manage their sales process. Thus, a user might maintain contact data, leads data, customer follow-up data, performance data, goals, and progress data, etc., all applicable to that user's personal sales process (e.g., in the tenant data storage 822). In an example of a MTS arrangement, since all of the data and the applications to access, view, modify, report, transmit, calculate, etc., may be maintained and accessed by a user system having nothing more than network access, the user can manage his or her sales efforts and cycles from any of many different user systems. For example, if a salesperson is visiting a customer and the customer has Internet access in their lobby, the salesperson can obtain critical updates as to that customer while waiting for the customer to arrive in the lobby.

While each user's data might be separate from other users' data regardless of the employers of each user, some data might be organization-wide data shared or accessible by a plurality of users or all of the users for a given organization that is a tenant. Thus, there might be some data structures managed by the system 816 that are allocated at the tenant level while other data structures might be managed at the user level. Because an MTS might support multiple tenants including possible competitors, the MTS should have security protocols that keep data, applications, and application use separate.

Also, because many tenants may opt for access to an MTS rather than maintain their own system, redundancy, up-time, and backup are additional functions that may be implemented in the MTS. In addition to user-specific data and tenant specific data, the system 816 might also maintain system level data usable by multiple tenants or other data. Such system level data might include industry reports, news, postings, and the like that are sharable among tenants.

In certain embodiments, the user systems 812 (which may be client systems) communicate with the application servers 900 to request and update system-level and tenant-level data from the system 816 that may require sending one or more queries to the tenant data storage 822 and/or the system data storage 824. The system 816 (e.g., an application server 900 in the system 816) automatically generates one or more SQL statements (e.g., one or more SQL queries) that are designed to access the desired information. The system data storage 824 may generate query plans to access the requested data from the database.

Each database can generally be viewed as a collection of objects, such as a set of logical tables, containing data fitted into predefined categories. A “table” is one representation of a data object, which may be used herein to simplify the conceptual description of objects and custom objects. It should be understood that “table” and “object” may be used interchangeably herein. Each table generally contains one or more data categories logically arranged as columns or fields in a viewable schema. Each row or record of a table contains an instance of data for each category defined by the fields.

For example, a CRM database may include a table that describes a customer with fields for basic contact information such as name, address, phone number, fax number, etc. Another table might describe a purchase order, including fields for information such as customer, product, sale price, date, etc. In some multi-tenant database systems, standard entity tables might be provided for use by all tenants. For CRM database applications, such standard entities might include tables for Account, Contact, Lead, and Opportunity data, each containing pre-defined fields. It should be understood that the word “entity” may also be used interchangeably herein with “object” and “table”.

In some multi-tenant database systems, tenants may be allowed to create and store custom objects, or they may be allowed to customize standard entities or objects, for example by creating custom fields for standard objects, including custom index fields. U.S. Pat. No. 7,779,039, filed Apr. 2, 2004, entitled “Custom Entities and Fields in a Multi-Tenant Database System”, which is hereby incorporated herein by reference, teaches systems and methods for creating custom objects as well as customizing standard objects in a multi-tenant database system. In certain embodiments, for example, all custom entity data rows are stored in a single multi-tenant physical table, which may contain multiple logical tables per organization. It is transparent to customers that their multiple “tables” are in fact stored in one large table or that their data may be stored in the same table as the data of other customers.

While one or more implementations have been described by way of example and in terms of the specific embodiments, it is to be understood that one or more implementations are not limited to the disclosed embodiments. To the contrary, it is intended to cover various modifications and similar arrangements as would be apparent to those skilled in the art. Therefore, the scope of the appended claims should be accorded the broadest interpretation so as to encompass all such modifications and similar arrangements.

1. A system for creating work order plans and steps based on mapped fields, the system comprising:
one or more processors; and
a non-transitory computer readable medium storing a plurality of instructions, which when executed, cause the one or more processors to:
receive, by a database system, an input to create a work order;
identify, by the database system, a work plan template object, a work plan instance object, a work step template object, and a work step instance object associated with the work order, in response to receiving the input to create the work order;
identify, by the database system, work plan fields which are mapped from the work plan template object to the work plan instance object, and work step fields which are mapped from the work step template object to the work step instance object;
create, by the database system, at least one work plan which comprises the mapped work plan fields in the work plan instance object and work steps which comprise the mapped work step fields in the work step instance object; and
cause, by the database system, the work order, comprising the at least one work plan, to be outputted.

2. The system of claim 1, comprising further instructions, which when executed, cause the one or more processors to create, by the database system, a work plan field in both the work plan template object and in the work plan instance object, and mapping between the work plan field in both the work plan template object and the work plan instance object, in response to receiving a request from a user of the database system to create and then map between the work plan field in both the work plan template object and the work plan instance object.

3. The system of claim 1, comprising further instructions, which when executed, cause the one or more processors to create, by the database system, a work step field in both the work step template object and in the work step instance object, and mapping between the work step field in both the work step template object and the work step instance object, in response to receiving a request from a user of the database system to create and then map between the work step field in both the work step template object and the work step instance object.

4. The system of claim 1, comprising further instructions, which when executed, cause the one or more processors to identify, by the database system, a work entity field which is mapped between a work entity object associated with the work order and at least one of the work plan instance object and the work step instance object, wherein the at least one work plan comprises the mapped work entity field.

5. The system of claim 1, wherein the input to create the work order is received from at least one of a system user and a software application that generates the input based on a maintenance plan.

6. The system of claim 1, wherein the input to create the work order is associated with at least one of an asset, a product, a work type, a service contract, a service territory, a location, and a customer account.

7. The system of claim 1, wherein at least one of the work steps is associated with at least one of an execution order, a start time, and a stop time.

8. A computer program product comprising computer-readable program code to be executed by one or more processors when retrieved from a non-transitory computer-readable medium, the program code including instructions to:
receive, by a database system, an input to create a work order;
identify, by the database system, a work plan template object, a work plan instance object, a work step template object, and a work step instance object associated with the work order, in response to receiving the input to create the work order;
identify, by the database system, work plan fields which are mapped from the work plan template object to the work plan instance object, and work step fields which are mapped from the work step template object to the work step instance object;
create, by the database system, at least one work plan which comprises the mapped work plan fields in the work plan instance object and work steps which comprise the mapped work step fields in the work step instance object; and
cause, by the database system, the work order, comprising the at least one work plan, to be outputted.

9. The computer program product of claim 8, wherein the program code comprises further instructions to create, by the database system, a work plan field in both the work plan template object and in the work plan instance object, and mapping between the work plan field in both the work plan template object and the work plan instance object, in response to receiving a request from a user of the database system to create and then map between the work plan field in both the work plan template object and the work plan instance object.

10. The computer program product of claim 8, wherein the program code comprises further instructions to create, by the database system, a work step field in both the work step template object and in the work step instance object, and mapping between the work step field in both the work step template object and the work step instance object, in response to receiving a request from a user of the database system to create and then map between the work step field in both the work step template object and the work step instance object.

11. The computer program product of claim 8, wherein the program code comprises further instructions to identify, by the database system, a work entity field which is mapped between a work entity object associated with the work order and at least one of the work plan instance object and the work step instance object, wherein the at least one work plan comprises the mapped work entity field.

12. The computer program product of claim 8, wherein the input to create the work order is received from at least one of a system user and a software application that generates the input based on a maintenance plan.

13. The computer program product of claim 8, wherein the input is to create the work order is associated with at least one of an asset, a product, a work type, a service contract, a service territory, a location, and a customer account.

14. The computer program product of claim 8, wherein at least one of the work steps is associated with at least one of execution order, a start time, and a stop time.

15. A computer-implemented method for mapping fields to create work order plans and steps, the computer-implemented method comprising:
receiving, by a database system, an input to create a work order;
identifying, by the database system, a work plan template object, a work plan instance object, a work step template object, and a work step instance object associated with the work order, in response to receiving the input to create the work order;
identifying, by the database system, work plan fields which are mapped from the work plan template object to the work plan instance object, and work step fields which are mapped from the work step template object to the work step instance object;
creating, by the database system, at least one work plan which comprises the mapped work plan fields in the work plan instance object and work steps which comprise the mapped work step fields in the work step instance object; and
causing, by the database system, the work order, comprising the at least one work plan, to be outputted.

16. The computer-implemented method of claim 15, the computer-implemented method further comprising creating, by the database system, a work plan field in both the work plan template object and in the work plan instance object, and mapping between the work plan field in both the work plan template object and the work plan instance object, in response to receiving a request from a user of the database system to create and then map between the work plan field in both the work plan template object and the work plan instance object.

17. The computer-implemented method of claim 15, the computer-implemented method further comprising creating, by the database system, a work step field in both the work step template object and in the work step instance object, and mapping between the work step field in both the work step template object and the work step instance object, in response to receiving a request from a user of the database system to create and then map between the work step field in both the work step template object and the work step instance object.

18. The computer-implemented method of claim 15, the computer-implemented method further comprising identifying, by the database system, a work entity field which is mapped between a work entity object associated with the work order and at least one of the work plan instance object and the work step instance object, wherein the at least one work plan comprises the mapped work entity field.

19. The computer-implemented method of claim 15, wherein the input to create the work order is received from at least one of a system user and a software application that generates the input based on a maintenance plan, and wherein the input to create the work order is associated with at least one of an asset, a product, a work type, a service contract, a service territory, a location, and a customer account.

20. The computer-implemented method of claim 15, wherein at least one of the work steps is associated with at least one of execution order, a start time, and a stop time.
